(19) United States
(12) Patent Application Publication
(10) Pub. No.: US 2023/0030419 A1
(43) Pub. Date: Feb. 2, 2023

(54) Machine Learning Model Training Method and Device and Electronic Equipment

(71) Applicant: BOE TECHNOLOGY GROUP CO., LTD., Chaoyang District, Beijing (CN)

(72) Inventor: Tingting Wang, Beijing (CN)

(21) Appl. No.: 17/788,608

(22) PCT Filed: Jul. 5, 2021
(86) PCT No.: PCT/CN2021/104517

§ 371 Date: Jun. 23, 2022

(30) Foreign Application Priority Data
Aug. 27, 2020 (CN) 202010878794.7

(51) Int. Cl. G06N 20/00; G06V 10/77; G06V 10/80; G06V 40/16

(52) U.S. Cl. CPC G06N 20/00; G06V 10/7715; G06V 10/80; G06V 40/178

(57) ABSTRACT

The invention relates to a machine learning model training method and device and electronic equipment, and relates to the technical field of artificial intelligence. The training method includes the following steps: inputting an image sample into a regression machine learning model, extracting a feature map of the image sample by utilizing the regression machine learning model, and determining an identification result of the image sample according to the feature map; inputting the feature map into a classification machine learning model, and determining the membership probability of the image sample belonging to each classification by using the classification machine learning model according to the feature map; calculating a first loss function according to the recognition result and the labeling result of the image sample, and calculating a second loss function according to the membership probability and the labeling result of the image sample; and training a regression machine learning model by using the first loss function and the second loss function.

### CROSS-REFERENCE TO RELATED APPLICATIONS

The present disclosure is a U.S. National Stage Application under 35 U.S.C. § 371 of International Patent Application No. PCT/CN2021/104517, filed on Jul. 5, 2021, which is based on and claims priority of Chinese application for invention No. 202010878794.7, filed on Aug. 27, 2020, the disclosure of both of which are hereby incorporated into this disclosure by reference in its entirety.

### TECHNICAL FIELD

The present disclosure relates to the technical field of artificial intelligence, and in particular, to a training method of a machine learning model, an apparatus for (training) a machine learning model, a age recognition method of a face image, an apparatus for age recognition based on a face image, an electronic device, and a nonvolatile computer-readable storage medium.

### BACKGROUND

Deep machine learning is one of the most important breakthroughs in the field of artificial intelligence in the past decade, and has achieved great success in many fields, such as speech recognition, natural language processing, computer vision, image and video analysis, and multimedia.

For example, face image processing technology based on deep machine learning is a very important research direction in computer vision tasks.

As an important biological feature of human beings, facial age information is needed by many applications in the field of human-computer interaction, and has an important impact on the performance of face recognition systems. Face-image-based age estimation refers to the application of computer technology to model the change of a face image with age, so that a computer can infer the approximate age of a person or an age range to which a person belongs based on a face image.

This technology has many applications, such as video surveillance, product recommendation, human-computer interaction, market analysis, user profiling, age progression, etc. If the problem of face-image-based age estimation can be solved, in our daily life, the demands of a great amount of applications for various age-based human-computer interaction systems can be satisfied.

Therefore, how to train a high-quality machine learning model is the basis for solving the needs of various artificial intelligence applications.

In the related art, a machine learning model is trained by using results output by the machine learning model itself and some pre-labeled results.

### SUMMARY

According to some embodiments of the present disclosure, a training method of a machine learning model is provided, comprising: inputting an image sample into a regression machine learning model; extracting a feature map of the image sample using the regression machine learning model, and determining a recognition result of the image sample according to the feature map; inputting the feature map into a classification machine learning model; according to the feature map, determining a membership probability that the image sample belongs to each class using the classification machine learning model; calculating a first loss function according to the recognition result and a labeling result of the image sample, and calculating a second loss function according to the membership probability and the labeling result of the image sample; training the regression machine learning model using the first loss function and the second loss function.

In some embodiments, training the regression machine learning model using the first loss function and the second loss function comprises: training the regression machine learning model using the first loss function, and then training the regression machine learning model using a weighted sum of the first loss function and the second loss function.

In some embodiments, training the regression machine learning model using the first loss function and the second loss function comprises: training the classification machine learning model using the second loss function, and then training the classification machine learning model using a weighted sum of the first loss function and the second loss function.

In some embodiments, calculating a second loss function according to the membership probability and the labeling result of the image sample comprises: calculating the second loss function according to a ratio of a number of image samples in a class to which the image sample belongs correctly to a total number of image samples, the second loss function being negatively correlated with the ratio.

In some embodiments, extracting a feature map of the image sample using the regression machine learning model comprises: extracting features in the image channels of the image sample for various image channels using the regression machine learning model; combining the features in the image channels into a feature map of the image sample.

In some embodiments, extracting features in the image channels of the image sample for various image channels using the regression machine learning model comprises: using the regression machine learning model, performing a convolution process on the image sample for different image channels respectively to extract the features in the image channels.

In some embodiments, according to the feature map, determining a membership probability that the image sample belongs to each class using the classification machine learning model comprises: using the classification machine learning model, determining correlation information between various image channels of the feature map; updating the feature map according to the correlation information; determining the membership probability that the image sample belongs to each class according to the updated feature map.

In some embodiments, updating the feature map according to the correlation information comprises: determining a weight of each channel feature according to the correlation information; weighing the features in the image channels corresponding to the weights using the weights; updating the feature map according to the weighted features in the image channels.

In some embodiments, the image sample is a face image sample, wherein the recognition result is an age of a face in the face image sample, and each class is an age-group class.

According to other embodiments of the present disclosure, there is provided an apparatus for training a machine learning model, comprising at least one processor configured to perform the steps of: inputting an image sample into a regression machine learning model, to extract a feature map of the image sample and determine a recognition result of the image sample according to the feature map using the regression machine learning model; inputting the feature map into a classification machine learning model, and according to the feature map, determining a membership probability that the image sample belongs to each class using the classification machine learning model; calculating a first loss function according to the recognition result and a labeling result of the image sample, and calculating a second loss function according to the membership probability and the labeling result of the image sample; training the regression machine learning model using the first loss function and the second loss function.

In some embodiments, training the regression machine learning model using the first loss function and the second loss function comprises: training the regression machine learning model using the first loss function, and then training the regression machine learning model using a weighted sum of the first loss function and the second loss function.

In some embodiments, training the regression machine learning model using the first loss function and the second loss function comprises: training the classification machine learning model using the second loss function, and then training the classification machine learning model using a weighted sum of the first loss function and the second loss function.

In some embodiments, calculating a second loss function according to the membership probability and the labeling result of the image sample comprises: calculating the second loss function according to a ratio of a number of image samples in a class to which the image sample belongs correctly to a total number of image samples, the second loss function being negatively correlated with the ratio.

In some embodiments, extracting a feature map of the image sample using the regression machine learning model comprises: extracting features in the image channels of the image sample for various image channels using the regression machine learning model; combining the features in the image channels into a feature map of the image sample.

In some embodiments, extracting features in the image channels of the image sample for various image channels using the regression machine learning model comprises: using the regression machine learning model, performing a convolution process on the image sample for different image channels respectively to extract the features in the image channels.

In some embodiments, according to the feature map, determining a membership probability that the image sample belongs to each class using the classification machine learning model comprises: using the classification machine learning model, determining correlation information between various image channels of the feature map; updating the feature map according to the correlation information; determining the membership probability that the image sample belongs to each class according to the updated feature map.

In some embodiments, updating the feature map according to the correlation information comprises: determining a weight of each channel feature according to the correlation information; weighing the features in the image channels corresponding to the weights using the weights; updating the feature map according to the weighted features in the image channels.

In some embodiments, the image sample is a face image sample, wherein the recognition result is an age of a face in the face image sample, and each class is an age-group class.

According to further embodiments of the present disclosure, there is provided a age recognition method of a face image, comprising: recognizing a facial age from the face image using a regression machine learning model that is trained by the training method in any of the above embodiments.

According to other embodiments of the present disclosure, there is provided an apparatus for age recognition based on a face image, comprising at least one processor configured to perform the steps of: recognizing a facial age from the face image using a regression machine learning model that is trained by the training method in any of the above embodiments.

According to further embodiments of the present disclosure, there is provided an electronic device comprising: a memory; a processor coupled to the memory, the processor configured to, based on instructions stored in the memory, carry out the training method of a machine learning model or the age recognition method of a face image in any one of the above embodiments.

According to still other embodiments of the present disclosure, there is provided a nonvolatile computer readable storage medium having stored thereon a computer program that, when executed by a processor, implements the training method of a machine learning model or the age recognition method of a face image in any one of the above embodiments.

### BRIEF DESCRIPTION OF THE DRAWINGS

The accompanying drawings, which are incorporated in and constitute a portion of this specification, illustrate embodiments of the present disclosure and, together with the description, serve to explain the principles of the present disclosure.

The present disclosure will be more clearly understood from the following detailed description with reference to the accompanying drawings, in which:

FIG. 1 shows a flowchart of some embodiments of a training method of a machine learning model of the present disclosure;

FIG. 2 shows a flowchart of some embodiments of step 110 in FIG. 1;

FIG. 3 shows a flowchart of some embodiments of step 120 in FIG. 1;

FIG. 4 shows a schematic diagram of some embodiments of the training method of a machine learning model of the present disclosure;

FIG. 5 shows a flowchart of some embodiments of the apparatus for training a machine learning model of the present disclosure;

FIG. 6 shows a block diagram of some embodiments of an electronic device of the present disclosure;

FIG. 7 shows a block diagram of other embodiments of the electronic device of the present disclosure.

### DETAILED DESCRIPTION

Various exemplary embodiments of the present disclosure will now be described in detail with reference to the accompanying drawings. Notice that, unless otherwise specified, the relative arrangement, numerical expressions and numerical values of the components and steps set forth in these examples do not limit the scope of the invention.

At the same time, it should be understood that, for ease of description, the dimensions of the various parts shown in the drawings are not drawn to actual proportions.

The following description of at least one exemplary embodiment is in fact merely illustrative and is in no way intended as a limitation to the invention, its application or use.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an article is defined in a drawing, there is no need for further discussion in the accompanying drawings.

The inventors of the present disclosure have found the following problems existed in the related art described above. The training effect cannot meet task demands, resulting in low processing capacity of machine learning models.

In view of this, the present disclosure proposes a technical solution for training a machine learning model, which can use a classification model to assist in training a regression model, thereby improving the processing capability of the machine learning model.

In some embodiments, a regression machine learning model (such as for age recognition) can be constructed by using a convolutional network with fewer parameters (such as a shuffle Net model), which can improve the processing speed while ensuring the processing accuracy. For classification problems that require fine processing granularity (such as the age classification problem), a classification machine learning model with fine processing granularity (such as the attention network) is used to assist in training. This allows, for example, to distinguish faces of different ages based on features such as facial complexion. For example, the technical solution of the present disclosure can be realized through the following embodiments.

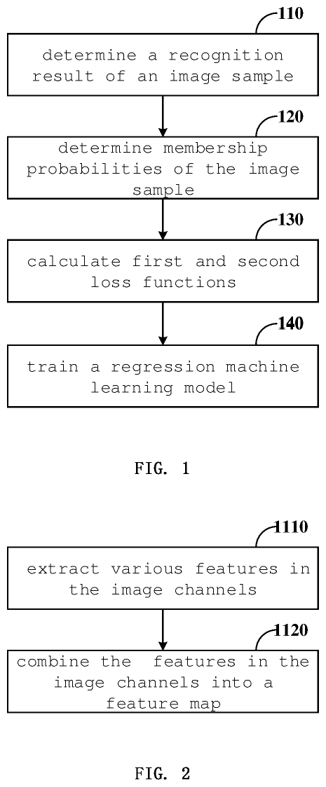

FIG. 1 shows a flowchart of some embodiments of a training method of a machine learning model of the present disclosure.

As shown in FIG. 1, the training method comprises: step 110: determining a recognition result of an image sample; step 120: determining membership probabilities of the image sample; step 130: calculating first and second loss functions; and step 140: training a regression machine learning model.

In step 110, an image sample is inputted into a regression machine learning model, extracting a feature map of the image sample using the regression machine learning model, and determining a recognition result of the image sample according to the feature map.

In some embodiments, the feature map may be extracted through the embodiment shown in FIG. 2.

FIG. 2 shows a flowchart of some embodiments of step 110 in FIG. 1.

As shown in FIG. 2, step 110 includes: step 1110: extracting various features in the image channels; and step 1120: combining the features in the image channels into a feature map.

In step 1110, features in the image channels of the image sample are extracted for various image channels using the regression machine learning model.

In some embodiments, using the regression machine learning model, a convolution process is performed on the image sample for different image channels respectively to extract the features in the image channels.

In step 1120, the features in the image channels are combined into a feature map of the image sample.

After extracting the feature map, the training can be continued with the remaining steps in FIG. 1.

In step 120, the feature map is inputted into a classification machine learning model; according to the feature map, a membership probability that the image sample belongs to each class is determined using the classification machine learning model.

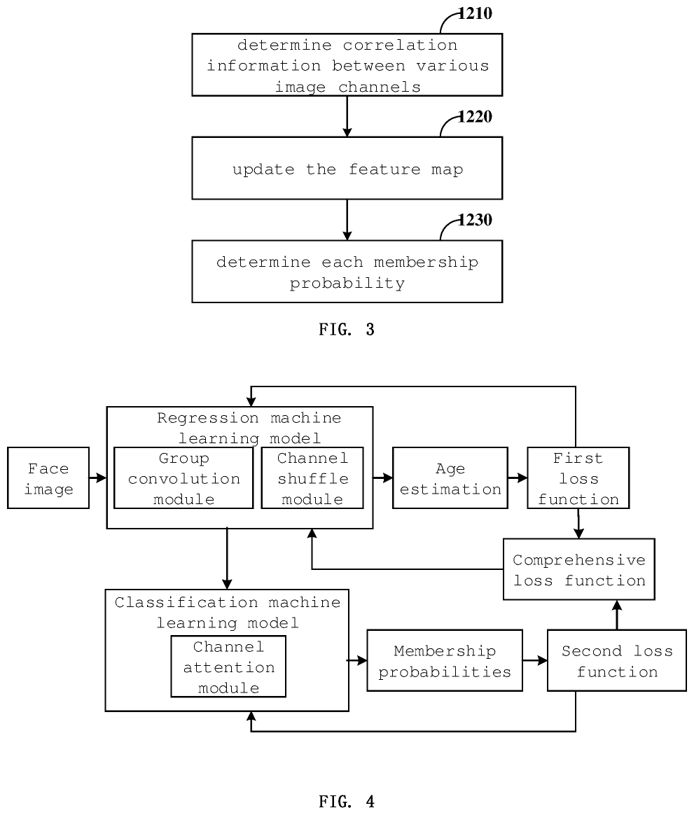

In some embodiments, the membership probability may be determined through the embodiment shown in FIG. 3.

FIG. 3 shows a flowchart of some embodiments of step 120 in FIG. 1.

As shown in FIG. 3, step S120 includes: step 1210: determining correlation information between various image channels. and step 1220: updating the feature map; and step 1230, determining each membership probability.

In step 1210, using the classification machine learning model, correlation information between various image channels of the feature map is determined. For example, correlation information between various features in the image channels of the feature map can be extracted as the correlation information between the various image channels.

In step 1220, the feature map is updated according to the correlation information.

In some embodiments, a weight is determined for each channel feature according to the correlation information; the feature map is updated according to the weighted features in the image channels.

In step 1230, a membership probability that the image sample belongs to each class is determined according to the updated feature map.

After determining the membership probabilities, the training can be continued with the remaining steps in FIG. 1.

In step 130, a first loss function is calculated according to the recognition result and a labeling result of the image sample. A second loss function is calculated according to the membership probability and the labeling result.

In some embodiments, the first loss function may be implemented as the Mae loss (Mean Absolute loss). For example, the first loss function can be:

L₁=|yᵢ−ŷᵢ|

For example, yᵢ is the labeling result of the image sample (such as a real age value), and ŷₗ is the recognition result output by the regression machine learning model (such as a predicted age value). Mae loss is insensitive to outliers, thereby improving the performance of the machine learning model.

In some embodiments, the second loss function is calculated according to a ratio of a number of samples in a class that the image sample belongs to in fact to a total sample number. The second loss function is negatively correlated with a ratio. For example, if the correct classification of the current image sample is class i, the number of samples in class i is ni, and the total number of samples in all classes is N, in this case, the second loss function is negatively related to a ratio of ni to N.

In this way, the problem of uneven distribution of the numbers of samples in the various sample classifications can be solved.

In some embodiments, the numbers of samples in the sample datasets of various age groups are not evenly distributed. For example, in particular, younger children and older adults over the age of 65 are less presented in the datasets. In this case, calculating the loss function through treating each age group equally would result in a lower training effect.

In this case, the Focal loss can be used to solve the problem that a ratio of different types of samples is unbalanced. For example, in conjunction with a multi-classification problem, the second loss function can be determined as:

L₂=class_weightᵢ(1−yᵢ×y_{i_label})^{γ}×log(y\acute{ }ᵢ×y_{i_label})

y\acute{ }ᵢ is the membership probability of the current image sample for class i. y_{i_label} is the labeling result of the current image sample for class i. For example, if the correct classification of the current image sample is class i, y_{i_label} is 1, otherwise it is 0. γ>0 is an adjustable hyperparameter, which can reduce the loss of easy-to-classify samples and make the training process focus more on difficult and misclassified samples.

class_weightᵢ is a ratio parameter of class i, and can be:

class_weightᵢ=N/(n_{class}×nᵢ)

n_{class} is the number of all classes.

In step 140, the regression machine learning model is trained using the first loss function and the second loss function.

In some embodiments, the regression machine learning model is trained using the first loss function, and then is trained using a weighted sum of the first loss function and the second loss function.

In some embodiments, the classification machine learning model is trained using the second loss function, and then is trained using a weighted sum of the first loss function and the second loss function.

For example, a weighted sum of the first loss function and the second loss function can be used to determine a comprehensive loss function L for training the regression machine learning model and the classification machine learning model:

L=L₁+L₂

In some embodiments, the image sample is a face image sample, wherein the recognition result is an age of a face in the face image sample, and each class is an age-group class. The regression machine learning model is used to estimate the facial age, and the classification machine learning model is used to determine membership probabilities that the face belongs to various age classes (such as age groups).

For example, a facial age can be recognized from the face image using a regression machine learning model that is trained by the training method described in any of the above embodiments.

FIG. 4 shows a schematic diagram of some embodiments of the training method of a machine learning model of the present disclosure.

As shown in FIG. 4, the entire network model can be divided into two parts: a regression machine learning model for extracting features and age estimation; a classification machine learning model with an attention mechanism module for calculating a membership probability for each class.

In some embodiments, the regression machine learning model may be constructed using the Group convolution module and the Channel shuffle module of Shuffle Net V2 (shuffle network).

In some embodiments, the group convolution module may group different feature maps of an input layer for different image channels. Then, different convolution kernels are used for convolution of the groups. For example, a group convolution module can be implemented using Depth Wise separable convolution, where the number of groups is equal to the number of input channels.

In this way, this channel sparse connection method can be used to reduce the calculation amount of convolution.

In some embodiments, after being processed by the group convolution module, the output is the convolution result of each group, that is, the feature of each channel. The group convolution results cannot achieve the purpose of feature communication between channels. In view of this, the channel shuffle module can be used to “recombine” the features in the image channels, so that the recombined feature map can contain components of all the features in the image channels.

In this way, it can be ensured that the group convolution module, which takes the recombined feature map as its input, can continue to perform feature extraction based on information from different channels. Therefore, this information can be communicated between different groups to improve the processing capability of the machine learning model.

For example, the regression machine learning model can include a Conv1_BR module. The Conv1_BR module can include a convolutional layer (such as 16 3×3 convolution kernels with stride of 2 and padding of 1) and a BR (Batch norm Relu) layer.

For example, after the conv1 BR module, multiple group convolution modules and multiple channel recombination modules can be alternately connected for feature map extraction.

For example, a Conv5_BR module can be connected after the multiple group convolution modules and channel recombination modules. The Conv5_BR module can include a convolutional layer (such as 32 1×1 convolution kernels with stride of 1 and padding of 0) and a BR layer.

For example, the Conv5_BR module can be followed by a Flatten layer, a full connection layer Fc1 (such as a full connection layer whose dimension is the number of age groups), a Softmax layer, and a full connection layer Fc2 (such as, with a dimension of 1). The output of Fc2 can be an age estimation.

In some embodiments, a CAM (Channel Attention mechanism) module of DANet (Dual Attention Network) can be used to construct a channel attention module in the classification machine learning model. The CAM module is used to extract the relationship (correlation information) between the features in the image channels. For example, the features in the image channels may be weighted according to the correlation information to update the features in the image channels.

In this way, the ability of the feature map to represent the image can be enhanced, thereby improving the processing capability of the machine learning model.

For example, the classification machine learning model can include a Conv6_BR layer connected after the CAM module. The Conv6_BR module can include a convolutional layer (such as 32 1×1 convolution kernels with stride of 1 and padding of 0) and a BR layer.

For example, a Flatten layer, a full connection layer Fc_f1 (such as a full connection layer with a dimension equal to the number of age values), and a Softmax layer can be connected after the Conv6_BR layer. The final output is the membership probabilities that the face belongs to various age values.

In some embodiments, the regression machine learning model may be trained according to a first loss function; the classification machine learning model may be trained according to a second loss function; and the regression machine learning model may be trained with a comprehensive loss function.

In the above embodiment, for the same processing task, the classification learning model is used to share the feature map extracted by the regression learning model, and assist in training the regression learning model. In this way, the machine learning model can be trained by combining classification processing and regression processing, thereby improving the processing capability of the machine learning model.

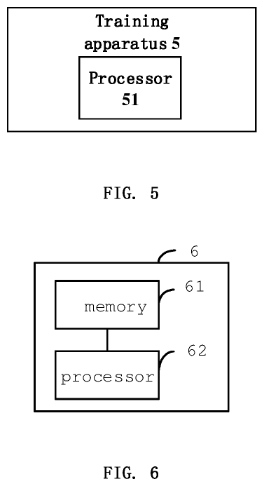

FIG. 5 shows a flowchart of some embodiments of the apparatus for training a machine learning model of the present disclosure.

As shown in FIG. 5, the apparatus 5 for training a machine learning model includes at least one processor 51. The processor 51 is configured to perform the training method described in any of the foregoing embodiments.

FIG. 6 shows a block diagram of some embodiments of an electronic device of the present disclosure.

As shown in FIG. 6, the electronic device 6 of this embodiment comprises: a memory 61 and a processor 62 coupled to the memory 61, the processor 62 configured to, based on instructions stored in the memory 61, carry out the training method of a machine learning model or the age recognition method of a face image described in any one of the embodiments of the present disclosure.

Wherein, the memory 61 may include, for example, system memory, a fixed non-transitory storage medium, or the like. The system memory stores, for example, an operating system, applications, a boot loader, a database, and other programs.

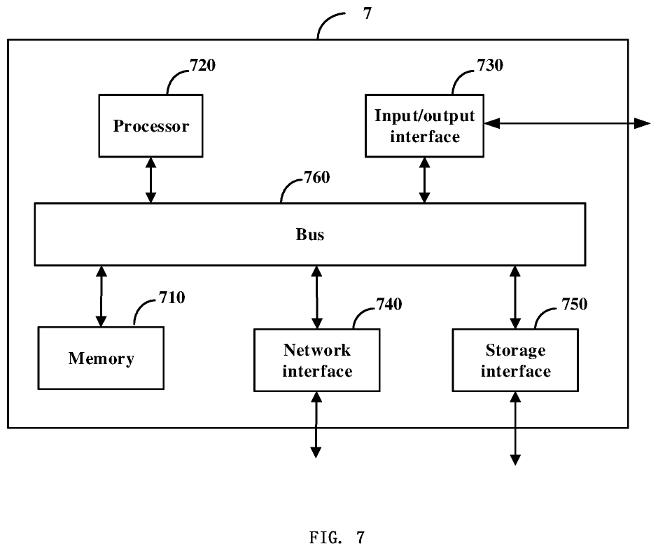

FIG. 7 shows a block diagram of other embodiments of the electronic device of the present disclosure.

As shown in FIG. 7, the electronic device 7 of this embodiment comprises: memory 710 and a processor 720 coupled to the memory 710, the processor 720 configured to, based on instructions stored in the memory 710, carry out the training method of a machine learning model or the age recognition method of a face image described in any of the foregoing embodiments.

The memory 710 may include, for example, system memory, a fixed non-transitory storage medium, or the like. The system memory stores, for example, an operating system, application programs, a boot loader (Boot Loader), and other programs.

The electronic device 7 may further comprise an input-output interface 730, a network interface 740, a storage interface 750, and the like. These interfaces 730, 740, 750 and the memory 710 and the processor 720 may be connected through a bus 760, for example. Wherein, the input-output interface 730 provides a connection interface for input-output devices such as a display, a mouse, a keyboard, a touch screen, a microphone, a loudspeaker, etc. The network interface 740 provides a connection interface for various networked devices. The storage interface 750 provides a connection interface for external storage devices such as an SD card and a USB flash disk.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disk storage, CD-ROM, optical storage device, etc.) having computer-usable program code embodied therein.

Heretofore, a training method of a machine learning model, an apparatus for (training) a machine learning model, a age recognition method of a face image, an apparatus for age recognition based on a face image, an electronic device, and a nonvolatile computer-readable storage medium according to the present disclosure have been described in detail. In order to avoid obscuring the concepts of the present disclosure, some details known in the art are not described. Based on the above description, those skilled in the art can understand how to implement the technical solutions disclosed herein.

The method and system of the present disclosure may be implemented in many ways. For example, the method and system of the present disclosure may be implemented by software, hardware, firmware, or any combination of software, hardware, and firmware. The above sequence of steps of the method is merely for the purpose of illustration, and the steps of the method of the present disclosure are not limited to the above-described specific order unless otherwise specified. In addition, in some embodiments, the present disclosure may also be implemented as programs recorded in a recording medium, which include machine-readable instructions for implementing the method according to the present disclosure. Thus, the present disclosure also covers a recording medium storing programs for executing the method according to the present disclosure.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

1. A training method of a machine learning model, comprising:
inputting an image sample into a regression machine learning model, to extract a feature map of the image sample and determine a recognition result of the image sample according to the feature map using the regression machine learning model;
inputting the feature map into a classification machine learning model, to determine a membership probability that the image sample belongs to a class using the classification machine learning model according to the feature map;
calculating a first loss function according to the recognition result and a labeling result of the image sample, and calculating a second loss function according to the membership probability and the labeling result of the image sample; and
training the regression machine learning model using the first loss function and the second loss function.

2. The training method according to claim 1, wherein the training the regression machine learning model using the first loss function and the second loss function comprises:
training the regression machine learning model using the first loss function, and then training the regression machine learning model using a weighted sum of the first loss function and the second loss function.

3. The training method according to claim 1, wherein the training the regression machine learning model using the first loss function and the second loss function comprises:
training the classification machine learning model using the second loss function, and then training the classification machine learning model using a weighted sum of the first loss function and the second loss function.

4. The training method according to claim 1, wherein the calculating a second loss function according to the membership probability and the labeling result of the image sample comprises:
calculating the second loss function according to a ratio of a number of image samples in a class to which the image sample belongs correctly to a total number of image samples, the second loss function being negatively correlated with the ratio.

5. The training method according to claim 1, wherein the extracting a feature map of the image sample using the regression machine learning model comprises:
extracting features in the image channels of the image sample for various image channels using the regression machine learning model; and
combining the features in the image channels into a feature map of the image sample.

6. The training method according to claim 5, wherein the extracting features in the image channels of the image sample for various image channels using the regression machine learning model comprises:
performing a convolution process on the image sample for different image channels respectively to extract the features in the image channels, by using the regression machine learning model.

7. The training method according to claim 1, wherein the according to the feature map, determining a membership probability that the image sample belongs to each class using the classification machine learning model comprises:
determining correlation information between various image channels of the feature map, using the classification machine learning model;
updating the feature map according to the correlation information; and
determining the membership probability that the image sample belongs to each class according to the updated feature map.

8. The training method according to claim 7, wherein the updating the feature map according to the correlation information comprises:
determining weights of features in the image channels according to the correlation information;
weighing the features in the image channels corresponding to the weights using the weights; and
updating the feature map according to weighted features in the image channels.

9. The training method according to claim 1, wherein the image sample is a face image sample, the recognition result is an age of a face in the face image sample, and the each class is an age-group class.

10. An age recognition method of a face image, comprising:
recognizing an age of a face in a face image using a regression machine learning model that is trained by the training method of claim 1.

11. A training apparatus of a machine learning model, comprising at least one processor configured to perform steps of:
inputting an image sample into a regression machine learning model, to extract a feature map of the image sample and determine a recognition result of the image sample according to the feature map using the regression machine learning model;
inputting the feature map into a classification machine learning model, and according to the feature map, determining a membership probability that the image sample belongs to each class using the classification machine learning model;
calculating a first loss function according to the recognition result and a labeling result of the image sample, and calculating a second loss function according to the membership probability and the labeling result of the image sample; and
training the regression machine learning model using the first loss function and the second loss function.

12. An age recognition apparatus of a face image, comprising at least one processor configured to perform steps of:
recognizing an age of a face in a face image using a regression machine learning model that is trained by the training method of claim 1.

13. An electronic device, comprising:
a memory; and
a processor coupled to the memory, the processor configured to, based on instructions stored in the memory, carry out the training method of a machine learning model of claim 1.

14. A non-transitory computer-readable storage medium on which a computer program is stored, which when executed by a processor implements the following steps of:
inputting an image sample into a regression machine learning model, to extract a feature map of the image sample and determine a recognition result of the image sample according to the feature map using the regression machine learning model;
inputting the feature map into a classification machine learning model, to determine a membership probability that the image sample belongs to a class using the classification machine learning model according to the feature map;
calculating a first loss function according to the recognition result and a labeling result of the image sample, and calculating a second loss function according to the membership probability and the labeling result of the image sample; and
training the regression machine learning model using the first loss function and the second loss function.

15. An electronic device, comprising:
a memory; and
a processor coupled to the memory, the processor configured to, based on instructions stored in the memory, carry out the age recognition method of a face image of claim 10.

16. A non-transitory computer-readable storage medium on which a computer program is stored, which when executed by a processor implements the age recognition method of a face image of claim 10.

17. The non-transitory computer-readable medium according to claim 14, wherein the program, when executed by the processor, implements the following steps of:
training the regression machine learning model using the first loss function, and then training the regression machine learning model using a weighted sum of the first loss function and the second loss function.

18. The non-transitory computer-readable medium according to claim 14, wherein the program, when executed by the processor, implements the following steps of:
training the classification machine learning model using the second loss function, and then training the classification machine learning model using a weighted sum of the first loss function and the second loss function.

19. The non-transitory computer-readable medium according to claim 14, wherein the program, when executed by the processor, implements the following steps of:
calculating the second loss function according to a ratio of a number of image samples in a class to which the image sample belongs correctly to a total number of image samples, the second loss function being negatively correlated with the ratio.

20. The non-transitory computer-readable medium according to claim 14, wherein the program, when executed by the processor, implements the following steps of:
extracting features in the image channels of the image sample for various image channels using the regression machine learning model; and
combining the features in the image channels into a feature map of the image sample.
